(19) United States
(12) Patent Application Publication
(10) Pub. No.: US 2019/0151781 A1
(43) Pub. Date: May 23, 2019

(54) PASSIVE DEVICES AND METHODS FOR SEPARATING INITIAL RAIN WATER RUNOFF AND SUBSEQUENT RAIN WATER RUNOFF

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Northport, NY (US)

(21) Appl. No.: 16/258,562

(22) Filed: Jan. 26, 2019

Related U.S. Application Data
(63) Continuation-in-part of application No. 15/610,555, filed on May 31, 2017.

(51) Int. Cl. B01D 29/96; B01D 29/58; B01D 29/52; B01D 35/02; B01D 35/143; B01D 35/34; C02F 1/00; C02F 1/44; E03F 5/04; E03F 5/06; B01D 61/38; B01D 65/02

(52) U.S. Cl. CPC B01D 29/96; C02F 2101/20; B01D 29/52; B01D 35/02; B01D 35/1435; B01D 35/34; C02F 1/001; C02F 1/44; E03F 5/0404; E03F 5/06; B01D 61/38; B01D 65/027; B01D 2317/04; B01D 2319/025; B01D 29/58

(57) ABSTRACT

A passive device for controlling rain water runoff. The device including: an inlet for directing the rain water runoff; and a mechanism for directing a predetermined initial amount of the rain water runoff to a first outlet and passively directing a subsequent amount of the rain water runoff to a second outlet.

### CROSS REFERENCE TO RELATED APPLICATION

This application is a Continuation In Part of U.S. patent application Ser. No. 15/610,555, filed on May 31, 2017, the entire contents of which are incorporated herein by reference.

### BACKGROUND OF THE INVENTION

### 1. Field of the Invention

The present invention relates to methods and devices for handling rain water run-off, emergency spills, and isolated regular discharge flows, and more particularly to passive methods and devices for handling rain water run-off and the like.

### 2. Prior Art

Filtering systems capable of filtering contaminants in liquid run-off/discharge are bulky, complicated and expensive. Further, such filtering systems can require a team of maintenance workers for repair or replacement.

### SUMMARY OF THE INVENTION

Accordingly, a passive device for controlling rain water runoff is provided. The device comprising: an inlet for directing the rain water runoff; and a mechanism for directing a predetermined initial amount of the rain water runoff to a first outlet and passively directing a subsequent amount of the rain water runoff to a second outlet.

The passive device can further comprise a first container having a first inlet fluidly connected to the first outlet for accumulating the predetermined initial amount of the rain water runoff. The passive device can further comprise a filtering system disposed in one of the first container or between the first outlet and the first inlet. The first container can further comprise a valve for varying an amount of the predetermined initial amount of the rain water runoff.

The passive device can further comprise a second container having a second inlet fluidly connected to the second outlet for accumulating the subsequent amount of the rain water runoff.

The mechanism can comprise: the first outlet and the second outlet comprising a common conduit that is movable between the first outlet and the second outlet; the first container is movable; and a linkage connected to the first container and to the common conduit such that upon the first container accommodating the predetermined initial amount of the rain water runoff, the linkage moves the common conduit from the first outlet to the second outlet. The passive device can further comprise a spring for biasing the first container towards a direction in which the first container is empty.

The mechanism can comprise: a filtering unit for accommodating the predetermined initial amount of the rain water runoff from the inlet, wherein the filtering unit is disposed between the inlet and the first outlet; and an outlet from the filtering unit is fluidly connected to the second outlet.

The mechanism can comprise: a valve disposed between the inlet and first and second outlets to selectively change flow of the rain water runoff from the inlet to one of the first outlet or second outlet; a conduit having a third outlet having a smaller flow rate than the first outlet, the conduit having an inlet in a flow of the rain water running toward the first outlet such that a portion of the rain water runoff flowing towards the first outlet can flow through the third outlet; a container having an inlet fluidly connected to the third outlet; and a sub-mechanism for passively turning the valve from the first outlet to the second outlet when the predetermined initial amount of the rain water runoff accumulates in the container. The sub-mechanism can comprise: the container is movable; the valve includes a lever for changing the flow of the rain water runoff from the inlet to one of the first outlet or second outlet; and a linkage connected to the container and to the lever such that upon the container accommodating the predetermined initial amount of the rain water runoff, the linkage changes the flow of the rain water runoff from the inlet to one of the first outlet or second outlet. The container can further comprise a valve for varying an amount of the predetermined initial amount of the rain water runoff.

The mechanism can comprise: a first container having a first inlet fluidly connected to the first outlet for accumulating the predetermined initial amount of the rain water runoff, the first inlet having a ball valve seat; and a ball movably restrained in the first container such that the ball seats in the ball valve seat when the predetermined initial amount of the rain water runoff accumulates in the first container.

Also provided is a method for passively controlling rain water runoff. The method comprising: directing the rain water runoff to an inlet; directing a predetermined initial amount of the rain water runoff to a first outlet; and passively directing a subsequent amount of the rain water runoff to a second outlet.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a top view of a rain run-off inlet for a modular contaminant filtering unit.

FIG. 2 illustrates a cross-sectional view as taken along line A-A in FIG. 1 of the modular rain water run-off contaminant filtering system.

FIG. 3 illustrates a cross-sectional view as taken along line B-B in FIG. 1 of the modular rain water run-off contaminant filtering system.

FIG. 4 illustrates a modular initial run-off water storage and filtering unit construction.

FIG. 5 illustrates a modular filtering unit construction without overflow passages.

FIG. 6 illustrates a cross-sectional view of a filtering system for handling regularly discharged contaminated flows.

FIG. 7 illustrates a cross-sectional view of a first embodiment of a rain water collection system with a mechanism for discarding a certain volume of an initial rain water discharge.

FIG. 8 illustrates a cross-sectional view of a second embodiment of a rain water collection system with an automatic mechanism to store filtered clean water in one storage tank and the rest of rain water in another storage tank for other uses.

FIG. 9 illustrates a cross-sectional view of an alternative passive mechanism for operating the rain water collection system of the embodiment of FIG. 7.

FIG. 10 illustrates a cross-sectional view of another alternative passive mechanism for operating the rain water collection system.

### DETAILED DESCRIPTION

A modular contaminant filtering system is disclosed herein that is suitable for many applications, in particular for filtering contaminants from rain water run-off in city streets, parks, river banks, coastal areas, and almost any other similar locations. The simple and adaptable design of the system and the modular and readily replaceable nature of its filtering units makes the system highly cost effective in terms of initial, running and maintenance costs. In this system, filtering “cartridge” units are readily replaced by a one-man crew or exchanged to handle fuel or other chemical spills in emergency situations. The basic design of the system lends itself also to use for filtering contaminated discharge from facilities such as small factories, food processing plants, larger cafeterias and restaurants, car washes, and the like that regularly discharge significant amounts of contaminated water into the environment.

The modular system is first described below for rain run-off filtering applications since it can provide a simple and low-cost method of eliminating most of its contaminants. The system can also be incorporated into the current street and park rain run-off inlets. The quick transformation of the system for emergency collection/filtering of spilled chemicals is then described, followed by its application to filtering nearly regular but relatively small flow of contaminated water discharged from relatively small service and production facilities.

When rain begins to fall over street or other similar surfaces, depending on its intensity and the level of accumulated contaminants over the surfaces, it would take a relatively short period of time until most contaminants are washed away. After such a period of time, the remaining rain water flows with minimal contaminant content. Thus, by filtering the initial flow of rain water run-off, most contaminants that have been accumulated over the affected surfaces can be removed. The amount of initial rain water flow to be filtered is dependent on the level and type of surface contaminants, the rain fall rate, surface area topology, among others factors.

In light of this concept, a novel contaminant filtering system for rain water run-off that can be readily implemented in city streets with minimal construction efforts is provided. The system, can include an added advantage of being fully modular, in the sense that the contaminant removing filtering units are readily replaceable and can be adapted to match the type of contaminants present in the run-off.

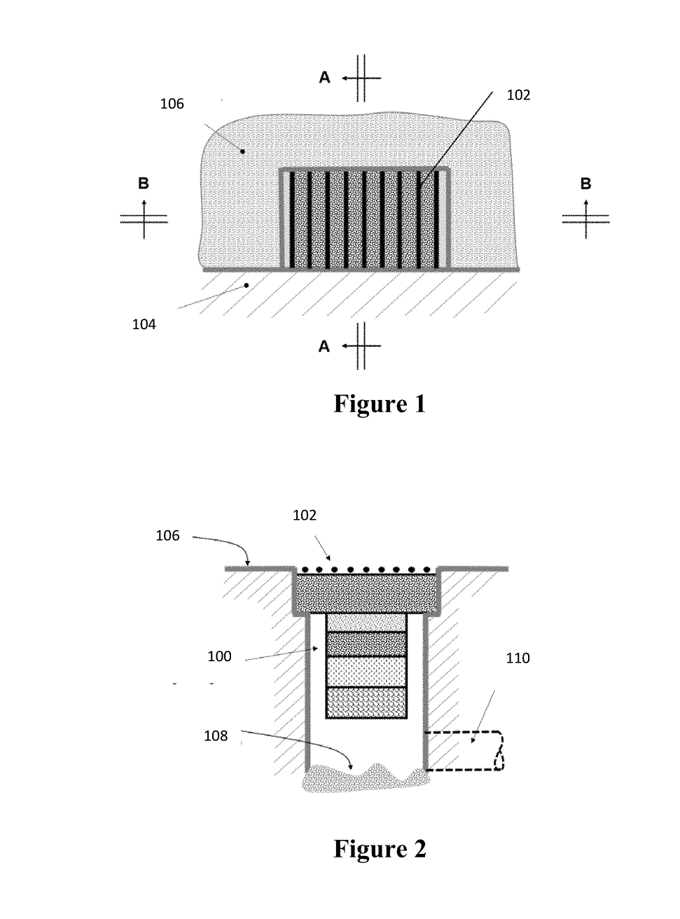

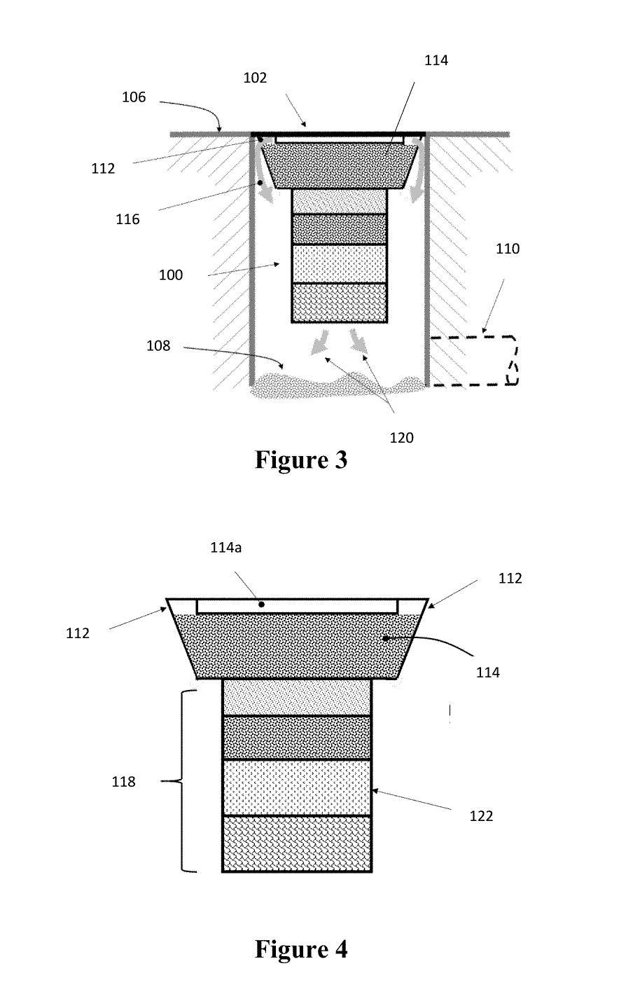

An embodiment and operation of a modular filtering system 100 is described below with reference to FIGS. 1-4. An existing rain water run-off inlet 102 at a curb 104 and at the street level 106 can be modified to adapt the present modular system. FIG. 1 shows a top view of the system. A commonly used rain run-off inlet cover 102 is shown to be used. The cross-sectional views A-A and B-B of the system as seen in the top view of FIG. 1 are shown in FIGS. 2 and 3, respectively. The readily replaceable “Modular initial run-off water storage and Filtering Unit” (MFU) is shown in FIG. 4. It is noted that when relatively large amounts of initial run-off water have to be filtered from relatively large surface areas, multiple MFUs may be provided to accommodate the filtering load.

As can be seen in the cross-sectional view A-A of FIG. 2, the modular filtering unit 100 is placed inside the provided space by removing the inlet cover 102. Lifting eyelets (not shown) can be provided on the modular filtering unit 100 structure so that it can be quickly attached to a lifting arm of a truck used for its quick replacement. To replace the modular filtering unit 100, the truck operator would attach the modular filtering unit 100 to the arm, lift it and place it over the truck bed. A clean modular filtering unit 100 would then be lowered in place with the same lifting arm. The process could not take as little as 4-5 minutes for each modular filtering unit 100. Each rain water run-off inlet 102 may be provided with several modular filtering units 100 depending on the size of the surface area to be serviced. A bottom surface of the space in which the modular filtering unit 100 is disposed can have gravel 108 and may have a pipe or outer conduit 110 to take away run-off processed by the modular filtering unit 100.

The cross-sectional view B-B from FIG. 1 is shown in FIG. 3. In this view, the modular filtering unit 100 includes overflow passages 112 provided on a top portion of the modular filtering unit 100. In operation, as the initial flow of rain water enters the modular filtering unit 100 though the top cover 102 of the inlet, it would first fill the indicated initial run-off storage container 114 and after that overflows through the provided overflow passages 112 at the top of the initial run-off storage container 114 and then into the provided space below (shown at 116), which may have been connected to a rain run-off collection system via the provided conduit 110. The initial run-off storage container 114 should be large enough to handle the required initial flow to achieve the desired level of contaminant removal capability or more than one modular filtering unit 100 may be employed.

Turning now to FIG. 4, the initial run-off storage container 114 can include an overflow fill region 114a corresponding to the overflow passages 112. The initial run-off storage container 114 can be at least partially filled with sand or other similar layers of different material, which can be used to filter larger solid contaminants. Whether fully filled or empty, the initial run-off storage container 114 can be capped with angled grids or similar means to prevent the run-off rain water from washing away the filling material or dilute the stored initial run-off water. The initial run-off water stored in the initial run-off storage container 114, which contains most of the washed-away contaminants, is then slowly filtered through one or more layers of filters 118 and discharged into the provided space below (shown at 120 in FIG. 3). The one or more layers of filters 118 can be rack mounted, such as on shelves, and individually replaceable so as to be customizable for a particular need.

The modular filtering unit 100 can be built with a structural frame 122 to accommodate several modular filtering layers 118 that can be packed into the lower compartment of the modular filtering unit 100 (the portion below the initial run-off container 114). The modular filtering unit 100 may be packed with different filtering layers 118 depending on the contaminants that are expected to be encountered. For example, with membranes to remove fuel residues, oil, fertilizer and other organic or heavy metals. The composition of the filtering layers 118 may be changed in minutes on-site or at the cleaning and re-stocking stations. The above described lifting eyelets can also be provided to the structural frame 122 to provide for a convenient way of lifting the entire modular filtering unit 100 above the street level 106 for east repair, replacement or reconfiguration of the filtering layers 118.

As discussed above, the modular filtering unit 100 disclosed above can be used to control spilled chemical removal. The construction of the modular filtering unit 100 can accommodate several filtering layers 118 as can be seen in the FIG. 4. The modular filtering unit 100 can be built with a structural frame 122 and shelf-like configuration to accommodate modular filtering layers 118 that are readily selected to adapt to the contaminating agents that are expected to be present in the run-off flow. As a result, the modular filtering unit 100 may be packed with different filtering layers 118 on-site by personnel handling hazardous material spilling conditions, such as fire department personnel. For example, filtering membranes may be quickly inserted into the modular filtering unit 100 to remove fuel residues, oil, fertilizer and other organic or heavy metals in a matter of minutes. In general, appropriate types of filtering layers 118 may also be stored, for example in fire stations, for quick insertion into the modular filtering unit 100 in case of such spills.

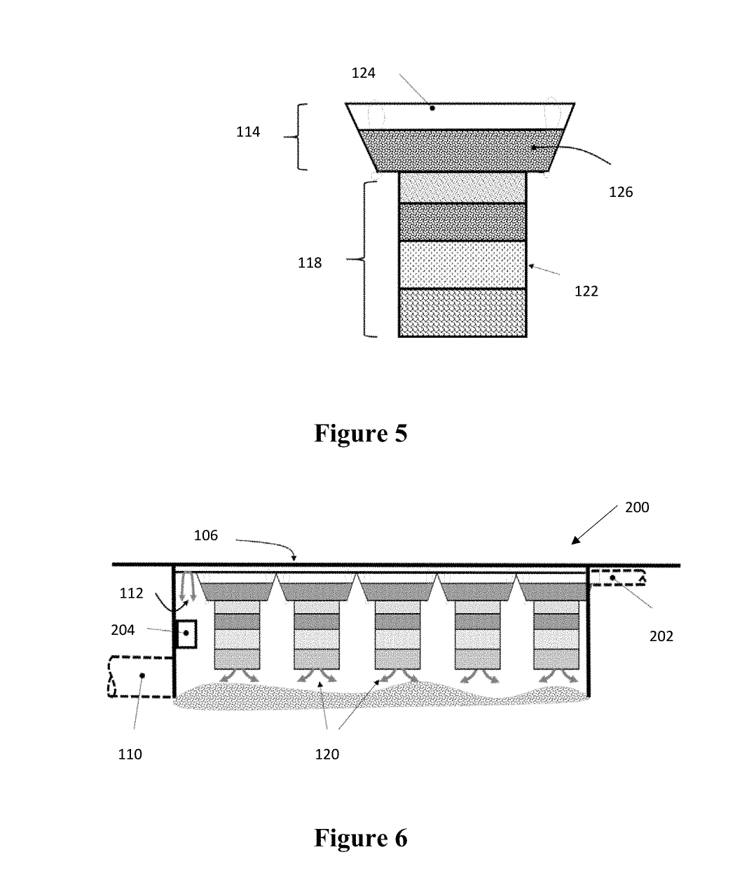

The modular filtering unit 100 disclosed herein can be readily adapted for filtering relatively small but regularly occurring discharges from facilities, such as small factories, food processing plants, larger cafeterias and restaurants, car washes, and other similar entities. In such applications, the modular filtering unit 100 may be installed with several in-series modular filtering units similar to the one shown in FIG. 4 to handle the peak flow, and be provided with filtering layers particularly selected for the contaminants present in the discharge. In these applications, the modular filtering unit 100 may be configured without the overflow passages of the modular filtering unit 100 of FIG. 4. A schematic of such a modular filtering unit 100 is shown in FIG. 5. In the configuration of FIG. 5, the initial run-off container 114 can be configured to have an empty portion 124 and a portion 126 filled with a pre-filtering material, such as large particle filtering sand.

A cross-sectional view of a modular filtering unit 200 installed to handle relatively small continuous or occasional discharges is shown in FIG. 6. In this configuration, the required number of modular filtering units 100 are positioned in-series along the path of the discharge flow to handle peak flow. The discharge flow channel may be covered as shown in FIG. 6 or may be open as shown in FIGS. 2 and 3. When closed, the discharge flow can be provided to the modular filtering unit 200 by an inlet conduit 202. The modular filtering unit 200 can also handle rain run-off water as discussed above and for such conditions, an end overflow discharge 112 can be provided. The overflow 112 would also handle cases of exceptionally high discharge rates that may occur.

As is shown in the schematic of FIG. 6, a flow activated sensor 204, such as a container with a float switch, can be provided to indicate the occurrence of an overflow event or blockage of the filter layers 118 (for example, by particulates being filtered). The container with float switch may be provided with small drainage holes such that once the overflow stops it is slowly emptied and readied to detect the next overflow. The float switch can be configured to output a notification, such as an alarm, to the facility that it is time to change the modular filtering units 100, unless the sensor 204 has been activated due to a heavy rain run-off flow. It is appreciated, however, that by providing a similar rain run-off detecting sensor 204 at a level above the discharge flow (not shown), the overflow due to rain run-off can be readily differentiated from that caused by the plant discharge flow.

In general, the modular filtering units 100 discussed above are useful for removal of contaminants collected on the surface of the ground (roadway, lawns, fields, etc), that are washed away by rain and flows into river, runoff collection and passages, etc. With such flow, the first few minutes will wash most of the contaminants, which are collected and slowly filtered by the modular filtering units 100 with a remainder of the flow overflowing from the modular filtering units 100. In this way, a very high percentage of the contaminants are extracted without the need for a large system.

Furthermore, with the use of a layered modular filtering system, the filters can be replaced regularly or cleaned and reused. The number of modular filtering units can be selected to match the area to be served and the expected volume of initial runoff to be filtered to achieve the desired level of contaminant removal.

The filter units 100 may serve as storage tanks for the collected initial runoff rain, etc., or separate tanks for storing the initial runoff rain may be provided. The latter can be provided with flaps that close the passage into the tank and allow the following runoff rain to overflow and run into runoff collection pipes, etc. In the former case, the top layer can be made to allow the initial runoff rain in until it cannot accommodate any more liquid and the remainder is overflown into collection pipes for removal. The top surface layer can be resistant to overflow water at its highest rate.

In the case of spillage of certain materials (solid or liquid), appropriate filter modules can be used to replace the normally used filters—or empty containers can be used to collect wash-off water, etc., used to clean up the contaminants. The empty modules may be used together with pumps to drain the module continuously or at different intervals and transfer into tankers or the like for removal.

A special delivery/removal truck can be used to automatically engage the modules and place it onto the truck and replace it with a clean filter.

The filter units 100 may be layered—with each layer being readily replaceable so that:

a. Only the contaminated layers may be replaced during the cleaning process; and

b. A desired combination of filter layers can be used depending on the season, for example to take out sand and salt during the winter months, or in the case of certain hazardous material spillage or the like;

Certain filter units 100 may be provided with internal pumping means or means of attaching a pumping connection to increase the rate of filtering.

The output of the filter unit 100 can be discharged into the rain water runoff pipes when present or into the storage volume for permeation into the ground below.

The filter unit 100 can be accessed directly from the ground surface after removing a top grid 102 or porous block or the like that allows unhindered flow of water into the filter unit 100. The grid 102 may be an integral part of the module, thereby eliminating the need to remove a first capping member to access the filter unit 100.

Alternatively—in particular in a plant yard or banks of a road, a channel may be provided in which provisions are made to drop in the required number of filter units 100 in the path of the flow of the runoff rain (or surface cleaning) water. The filter units 100 would then collect and slowly filter the predetermined amount of initial runoff water that is needed to filter the desired percentage of contaminants that is expected to be present on the surface of the road or lawn, etc.

When used to filter a continuously discharged contaminated water, for example from a plant, enough filter units 100 can be placed along the passage (e.g., provided channel) to allow the entire discharge to be continuously discharged. The filter units 100 can then be periodically replaced as the filtering rate (throughput) is reduced. The throughput reduction can be readily observed (detected) when the flow moves farther downstream than a threshold distance. At this time the oldest filter units 100 can be replaced until the desired throughput is achieved. The filter unit 100 housings can be provided with locking flaps or the like that prevent from after the filter unit 100 has been pulled out a certain distance. Alternatively, a lever can be provided that is used to close the outlet from the filter unit 100 housing before the filter unit 100 is removed and is opened after its replacement.

The filter unit 100 can be configured such that the inflow goes through a sediment separation section and then flow into the filter layers 118.

The storage portion 114 and filtering layers 118 may be provided in two separate pieces and each replaced as needed.

Filtering layers 118 can be stored in fire departments or the like for on-site replacement in the case of fuel or other chemical spills.

For regular discharge from different facilities such as small factories, food processing plants, fish markets, restaurants, etc., more than one can be placed in-series and/or in-parallel to accommodate the discharge (mostly occurring slowly or once in a while). Such units can be provided with end overflow passage, FIG. 6, for sudden surge that cannot be handled or rain run-off that may overwhelm the system. The end overflow sensor 204 (e.g., bucket with float switch) can be used to alert the user that overflow has occurred or that MFUs have to be replaced. A similar bucket sensor (not shown) can be placed above the inlet level to collect rain run-off to allow the monitoring system to differentiate overflow events occurred due to the rain from those occurring due to the discharge overflow.

The filter units 100 can be provided with eyelets for attachment to a lifting arm on a truck used to remove and replace or install a filter unit 100. The rain run-off inlet cover 102 may be integral to the filter unit 100 and may be used in place of the eyelets.

In many areas around the work, for example in many Caribbean islands, the drinking and the water used for bathing, washing and for watering plants are collected from rain water. In many other places rain water is also collected to supplement other sources of unsalted or water with heavy mineral contents. In such cases, the surfaces used to collect water, such as rooftop surfaces and other passages are soiled by dust and many other air-carried contaminants and in many cases with bird droppings in between rainfalls. In these situations, the collected water is contaminated and must be filtered for use, even for bathing and washing purposes. The water storage tank is also contaminated and allow the growth of bacteria, algae and other unwanted organisms in the storage tanks.

However, as was described earlier, when rain begins to fall over the building rooftop and other passage surfaces used for collecting rain water, depending on its intensity and the level of accumulated contaminants over the surfaces, it would take a relatively short period of time until most contaminants are washed away. After such a period of time, the remaining rain water flows with minimal and eventually with negligible contaminant content. Thus, by discarding the initial flow of rain water, or storing it for uses other than drinking purposes, the follow up rain water can be stored for safe consumption.

It will be appreciated that when the contaminants are mainly dust and bird droppings and the like, the initial rain water flow containing such contaminants are good for watering plants and may be directed directly for such use or partially or fully stored for later plant watering. In addition, once a substantial part of the contaminants is washed away and used directly and/or stored for later plant irrigation, the rain water is clean enough for bathing and other similar uses and may be stored for such uses.

In light of the above water collection concepts for safe human consumption, for bathing and similar other use as well as for direct use or storage for later irrigation purposes, novel passive mechanisms for properly directing the rain water flow are provided. The disclosed passive mechanisms are configured to automatically route the rain water flow to the intended storage and/or other destination as described above. The system may also be readily provided with various water filtration as described in the above embodiments and/or may be provided with UV disinfection devices or other disinfection devices.

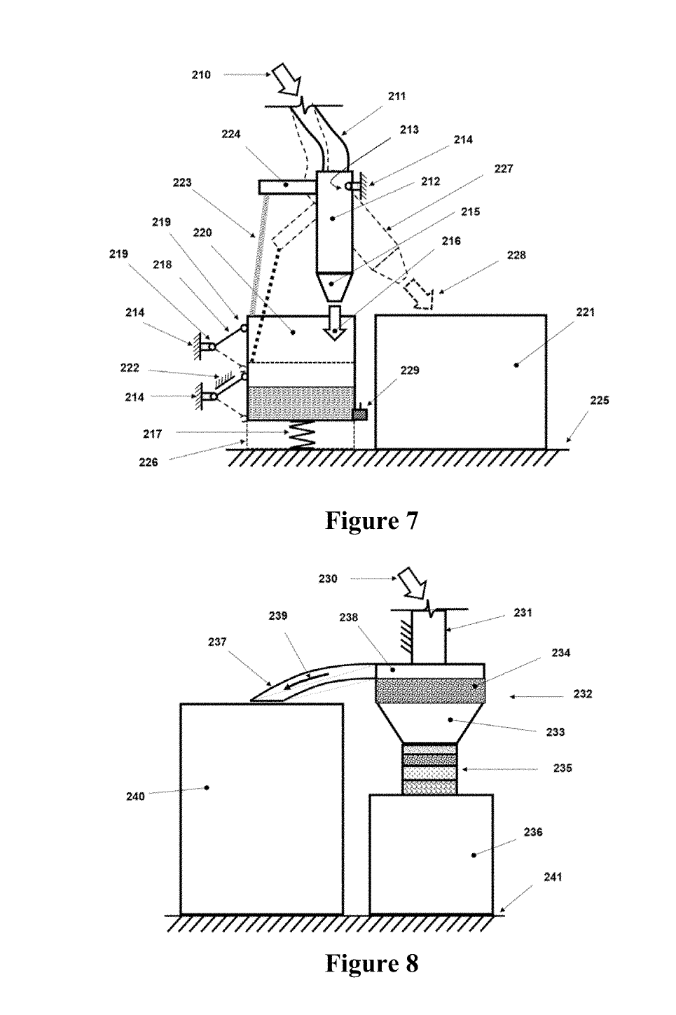

The first rain water collection system embodiment with a passive mechanism to discard an initial volume of the rain water is shown in the cross-sectional schematic view of FIG. 7. Here, the term passive is intended to mean that the mechanism requires no external power, such as electrical power, for properly performing its function as described below. It will also be appreciated that the system and initial rain water volume discarding mechanism shown in FIG. 7 is provided primarily for the purpose of describing the method of its passive operation, without intending to limit the disclosed system to this presented passive mechanism, as numerous other mechanism may also be employed to perform the described function, several of which are provided later in this disclosure.

In the schematic of FIG. 7, the rain water is considered to be flowing from the roof or certain passages (not shown) down as shown by the arrow 210 into a flexible tubing (hose) 211. The flowing rain water is then discharged from the hose 211 into a relatively rigid “tubing” member 212, which may be provided with a conical discharge end 215, through which the flowing rain water would discharge into the collection container 220 as shown by the arrow 216 or the collection container 221 as described below. The tubing member 212 is fixedly attached to the structure of the building 214 (directly or via some other intermediate structure) that is providing the rain water that is flowing over its roof or other passage surfaces (not shown) by the rotary joint 213. In the position of the tubing member 212 shown in FIG. 7 by solid lines, the rain water is being discharged into the collection container 220 as shown by the arrow 216. The collection container 220 is also attached to the structure of the building 214 or directly to a separate structure provided away from the structure of the building (not shown) by the links 218 via two rotary joints 219, so that the collection container 220 is essentially constrained to a vertical (up and down as seen in the view of the FIG. 7).

While the collection container 220 is empty, the compressive spring 217 is provided to keep the collection container 220 in the position shown by solid lines in FIG. 7. It will be appreciated by those skilled in the art that the compressive spring 217 may be preloaded so that a certain amount of water needs to fill the collection container 220 before the collection container would begin to move down. In which case, a stop element, such as the stop 222 on the structure of the building, is provided to limit upward movement of the collection container. In the FIG. 7 the stop is shown to be provided against one of the links 218, but it might be provided against the collection container 220 itself or any other member that is fixedly attached to it.

Now once the rain water begins to flow from the roof or certain provided passages into the member 212 as shown by the arrow 210 in FIG. 7, it would begin to fill the collection container 220. Then once the collection container 220 has been filled enough to overcome the biasing upward force of the compressive spring 217, then the collection container will begin to move down, thereby beginning to pull on the cable (rope or chain or the like) 223, shown in FIG. 7. The cable 223 is attached on one end to the collection container 220 and on the other end to the arm 224 that is fixedly attached to the tubing member 212. Thus, as the water keeps on further filling the collection container 220, the resulting downward motion of the collection container further pulls the cable 223 down, thereby causing the member 212 to rotate in the counter-clockwise direction as seen in the view of FIG. 7. Then as the collection container 220 reaches its downward motion limit as shown by the dashed line 216, for example by reaching the ground surface 225 or certain other provided surface structure, the member 212 is rotated to the position shown by the dashed lines and indicated by the numeral 227, and the rain water begins to flow into the collection container 221 as shown by the arrow 228.

In this first embodiment of the rain water collection system with a mechanism for discarding certain volume of the initial rain water discharge, the collection container 220 is sized to collect the initial rain water flow, which is determined to be enough to wash the collected contaminants over the roof and other existing passages. Then once the surfaces are essentially cleaned of the contaminants, the clean water is directed into the second collection container 221 for storage.

The collection container 220 may be provided with a discharge valve 229 that can be used to empty the collection container after each rain event and to provide for a desired rate of discharge so that a larger amount of the initial rain water flow must be provided before the collection container descends and the rain water begin to flow into the collection container 221. The increase in the initial rain water flow before considering the rain water clean enough for storage in the collection container 221 may be needed if a long period of time has passed between rain falls and/or more than usual amounts of dirt and other contaminants are expected to have been collected over the roof and other flow passages.

It will be appreciated that in certain locations where rain water is collected for watering plants and other outdoor uses as well as for drinking and household use, the initial rain water flow usually does not have to be discarded and may be routed to a relatively large storage unit and/or be used directly to water plants and for other similar use. Alternatively, the initial rain water collected in collection container 220 can be used to input a contaminant filtering system.

FIG. 8 shows a cross-sectional schematic of the second rain water collection system embodiment with a passive mechanism for filtering and storing a portion of the rain water in one storage tank and storing another portion of the rain water in a second storage tank and/or directing it to a field to water plants or for other similar use. In this embodiment, the rain water is also considered to be flowing from the roof or certain passages (not shown) down as shown by the arrow 230 into the tubing 231. The rain water then flows into the container 232, which is provided with a layer of pre-filtering material, such as large particle filtering sand 234. The rain water will then flow through the pre-filtering material 234 into the provided space 233 and is then passed through the replaceable filtering unit 235 into the clean water storage tank 236.

As the rain water begins to flow through the tubing 231 into the container 232, the initial rain water is mostly passed thought the pre-filtering material 234, the larger contaminant material are filtered and the water begins to collect in the compartment 233 of the container 232, while being filtered by the filtering unit 235 and collecting in the clean water storage tank 236. Then depending on the incoming rain water flow rate and the size of the container 232, either from essentially the very start of the rain water inflow or after the compartment 233 is filled and the pre-filtering material 234 is saturated, the rest of the rain water flows out through the pipe 237 from the top region 238 of the container 232 as shown by the arrow 239 into the water storage tank or pool 240, or is directly discarded or directed to flow into a field or the like to water plants or for other appropriate use. The water storage tanks 236 and/or 240 may be indoor or located on outdoor grounds 241.

It will be appreciated by those skilled in the art that the features of the embodiments of FIGS. 7 and 8 may be readily combined to obtain alternative embodiments with added capabilities as described below.

In one alternative embodiment (not shown), the initial rain water that contains most of the contaminants flows into the collection container 220 as was described for the embodiment of FIG. 7. Once the collection container has been filled to the required level and has displaced down to its lower position 226, then the rain water (shown by the arrow 228) is directed to flow into the tubing 231 as shown by the arrow 230 in FIG. 8. As a result, the initial heavily contaminated rain water is collected in the collection container 220 and is discarded via the drain valve 229 or by other means. Hence, the rain water collected in the storage tank 240, FIG. 8, even though is not as clean as the rain water collected in the storage tanks 236 and suitable for drinking and the like, but it would be suitable for purposes such as bathing and other similar uses.

It will be appreciated by those skilled in the art that a container at least partially filled with pre-filtering material (234 in FIG. 8) may also be provided for the embodiment of FIG. 7. Such a container would be placed before the tubing member 211, FIG. 7, into which flows the rain water shown by the arrow 210 and through which into the tubing member 211.

It will also be appreciated by those skilled in the art that in the embodiment of FIG. 8, the rain water flowing out of the filter 235 may be passed through a commonly available ultraviolet (UV) water disinfecting unit to rid water of any microorganisms that may have passed through the filter 235.

It will be appreciated by those skilled in the art that instead of using two storage tanks as shown in the embodiments of FIGS. 7 and 8, the system may be configured with more storage tanks, for example, one for drinking water (such as 236 in the embodiment of FIG. 8), the first overflow tank (240 in FIG. 8), by the water flowing through a second filtering unit (similar to the unit 232 in FIG. 8), the overflow of which fills a second overflow tank (not shown) of runs into a field or the like to water plants or is discarded. It is appreciated that many such combinations of storage tanks and filtering units for extracting and storing drinking quality, fairly clean and least contaminant free rain water may be achieved.

It will be appreciated that the passive mechanism for discarding (redirecting) initial rain water shown in the schematic view of FIG. 7 was provided primarily for the purpose of describing the functionality of such a passive mechanism and the basic method of operation of a rain water collection system using such a passive mechanism and was not intended to limit the disclosed system to this specific passive mechanism. In fact, numerous other mechanisms may also be provided to perform the described function, two of which are described below.

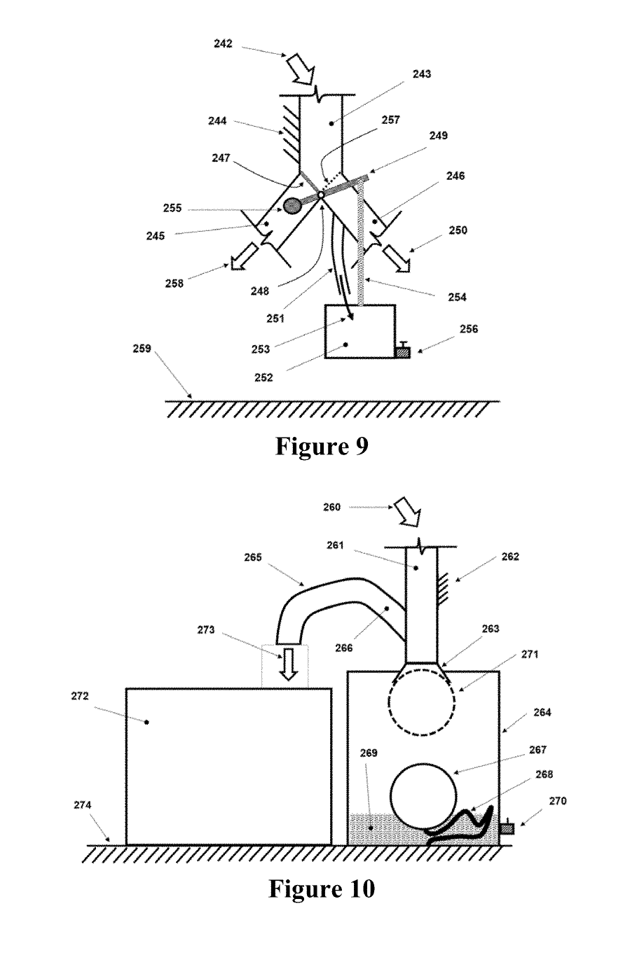

A first alternative passive mechanism for operating the rain water collection system of the embodiment of FIG. 7 is shown in the schematic of FIG. 9. In this embodiment, the rain water is considered to be flowing from the roof or certain passages (not shown) down as shown by the arrow 242 into the tubing 243. The tubing 243 is fixedly attached to the structure of the building 244 (directly or via some other intermediate structure) that is providing the rain water. The lower section of the tubing 243 is connected to two tubing branches 255 and 256. A valve with the flap 247 is provided that in the configuration shown in FIG. 9 prevents the incoming rain water from entering the tubing 245. As a result, in this configuration the rain water can only flow through the tubing 246 and exit as shown by the arrow 250. The valve flap 247 is fixed to the shaft of the rotary joint 248. It is noted that the shaft of the rotary joint 248 runs inside the junction of the tubing 243, 245 and 246 (not visible in the cross-sectional view of FIG. 9). The shaft of the rotary joint 248 runs outside the joint, at which point it is fixedly attached to the handle 249.

The tubing 246 is also provided with a smaller branch 251, through which part of the rain water flows into the container 252 as shown by the arrow 253. The container 252 is attached to the handle 249 by a cable 254. In the configuration of FIG. 9, the weight of the empty container is overcome by the counterweight 255, which is attached to the handle 249 on the end opposite to the point of cable 254 attachment. As a result, the flap 247 is kept in the position shown in FIG. 9 and forces the rain water to flow through the tubing 246.

Now once the rain water begins to flow from the roof or certain provided passages into the tubing 243 as shown by the arrow 242 in FIG. 9, the flap 247 is in the position shown and the rain water begins to flow through the tubing 246 in the direction of the arrow 250 into a first storage tank or pool (not shown—similar to the tank 240 in the embodiment of FIG. 8) for storing the least clean (contaminated) rain water or is discarded or used directly for watering plants or the like. In the meanwhile, a relatively small fraction of the rain water flowing through the tubing 246 flows into the container 252 through the tubing 251. The container 252 may also be provided with an adjustable valve 256 to provide part of the rain water to be drained, thereby allowing the rate at which the rain water accumulates in the container 252 to be adjusted.

The diverted portion of the rain water will keep accumulating in the container 252 until the clockwise moment exerted by the weight of the container 252 and the collected water about the rotary joint 248 overcomes the counter-clockwise moment due to the counterweight 255, thereby beginning to rotate the lever 249 in the clockwise direction until the flap 247 is rotated to the position 257 (shown in dotted line in FIG. 9), thereby diverting the flow of the rain water from the tubing 246 to the tubing 245. As a result, the rain water begins to flow out of the tubing 245 as shown by the arrow 258, and into a clean water collection tank (not shown—similar to the tank 236 in FIG. 8). The valve 256 is manually set to allow the required amount of the rain water to flow out of the tubing 246 until the rain water is essentially clean for storage in the clean water storage tank. It is appreciated that enough space must be provided between the container 252 and the ground surface 259 to allow for its required vertical motion.

It will be appreciated by those skilled in the art that a container at least partially filled with pre-filtering material (234 in FIG. 8) may also be provided for the embodiment of FIG. 9. Such a container would be placed along the path of rain water flow in the tubing 243, FIG. 9, into which flows the rain water shown by the arrow 242.

It will also be appreciated by those skilled in the art that a removable filter, such as the removable filter 235 in the embodiment of FIG. 8, may be provided along the length of the tubing 245 to filter the water before it flows into the aforementioned clean water storage tank. It will also be appreciated by those skilled in the art that in the embodiment of FIG. 9, the rain water flowing out of the tubing 258 may be passed through a commonly available ultraviolet (UV) water disinfecting unit (downstream to the said removable filter—if provided) to rid water of any microorganisms that may have passed through the filter 235.

A second alternative passive mechanism for operating the rain water collection system is shown in the schematic of FIG. 10. In this embodiment, the rain water is considered to be flowing from the roof or certain passages (not shown) down as shown by the arrow 260 into the tubing 261. The tubing 261 is fixedly attached to the structure of the building 262 (directly or via some other intermediate structure) that is providing the rain water. The lower section of the tubing 261 is connected to a conical section 263, through which the incoming rain water can flow into the container 264. A tubing member 265 is also attached to the tubing 261 as shown in FIG. 10. The tubing member 265 is provided with an upward section 266, which prevents the rain water from flowing into it while it is flowing freely down the tubing 261 into the container 264.

Once the rain water begins to flow from the roof or certain provided passages into the tubing 261 as shown by the arrow 260 in FIG. 10, the rain water travels down the tubing 261 and through the conical section 263 into the container 264, thereby storing the least clean (contaminated initial) rain water in this container.

Inside the container 264, a ball float 267 is positioned and tied to the bottom surface of the container 264 by a flexible cable (chain, cord, or the like) 268. Therefore, while the container 264 is empty, the ball float 267 stays at the bottom of the container. Then as the water begins to collect in the container 264 (as shown in FIG. 10 and indicated by the numeral 269), the ball float 267 is raised as shown in FIG. 10. The container 264 may also be provided with an adjustable valve 270 to provide part of the rain water to be drained, thereby allowing the rate at which the rain water accumulates in the container 264 to be adjusted.

The initial rain water flow will keep accumulating in the container 264 until the ball float 267 is pushed up and is pressed against the conical section 263 (shown with dashed line and indicated by the numeral 271), thereby closing the flow of rain water into the container 264. It will be appreciated that the combination of the conical section 263 and the ball float 267 form a ball valve and for best sealing action, the surface of the ball float 267 and/or the interior of the conical section 263 may be covered by elastomeric type materials.

Then once the flow of rain water into the container is blocked by the ball float 267, then the rain water backs up in the tubing 265 and is forced to flow through it to flow into the clean water collection container 272 as shown by the arrow 273. The valve 270 is manually set to allow the required amount of the rain water to flow into the initial rain water flow collection container 264 before it is essentially clean to be collected in the clean water collection container 272. The rain water flowing out of the valve 270 may be collected in a separate storage tank or used directly to water plants or discarded.

It will be appreciated by those skilled in the art that a container at least partially filled with pre-filtering material (234 in FIG. 8) may also be provided for the embodiment of FIG. 10. Such a container would be placed along the path of rain water flow into the tubing 261, FIG. 10, into which the rain water shown by the arrow 242 will flow before flowing into either storage containers.

It will also be appreciated by those skilled in the art that a removable filter, such as the removable filter 235 in the embodiment of FIG. 8, may be provided along the length of the tubing 265 to filter the water before it flows into the clean water storage tank 272.

It will also be appreciated by those skilled in the art that the rain water flowing out of the tubing 258 may be passed through a commonly available ultraviolet (UV) water disinfecting unit (downstream to the said removable filter 235—if provided) to rid water of any microorganisms that may have passed through the removable filter.

It will also be appreciated by those skilled in the art that the passive mechanisms of the embodiments of FIGS. 7 and 9 may also be readily designed for manual operation.

It will also be appreciated by those skilled in the art that passive mechanisms of the embodiments of FIGS. 7 and 9 may be provided with active means of operation. For example, an electric motor or other actuation means such as pneumatic pistons may be provided to rotate the tubing 212 in the embodiment of FIG. 7 to the position 227 as indicated by the dashed lines once a certain amount of time has elapsed from the beginning of the rainfall or once a provided water quality sensory element has indicated that the flowing rain water is essentially clean for storage. In which case, the container 220 and its operating mechanisms are no longer needed, and the initial rain water can be directly discarded or stored in a storage tank or pool. Similar methods may be used to operate the handle 249 of the embodiment of FIG. 9.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A passive device for controlling rain water runoff, the device comprising:
an inlet for directing the rain water runoff; and
a mechanism for directing a predetermined initial amount of the rain water runoff to a first outlet and passively directing a subsequent amount of the rain water runoff to a second outlet.

2. The passive device according to claim 1, further comprising a first container having a first inlet fluidly connected to the first outlet for accumulating the predetermined initial amount of the rain water runoff

3. The passive device according to claim 2, further comprising a filtering system disposed in one of the first container or between the first outlet and the first inlet.

4. The passive device according to claim 2, wherein the first container further comprises a valve for varying an amount of the predetermined initial amount of the rain water runoff.

5. The passive device according to claim 1, further comprising a second container having a second inlet fluidly connected to the second outlet for accumulating the subsequent amount of the rain water runoff.

6. The passive device according to claim 1, wherein the mechanism comprises:
the first outlet and the second outlet comprising a common conduit that is movable between the first outlet and the second outlet;
the first container is movable; and
a linkage connected to the first container and to the common conduit such that upon the first container accommodating the predetermined initial amount of the rain water runoff, the linkage moves the common conduit from the first outlet to the second outlet.

7. The passive device according to claim 6, further comprising a spring for biasing the first container towards a direction in which the first container is empty.

8. The passive device according to claim 1, wherein the mechanism comprises:
a filtering unit for accommodating the predetermined initial amount of the rain water runoff from the inlet,
wherein the filtering unit is disposed between the inlet and the first outlet; and
an outlet from the filtering unit is fluidly connected to the second outlet.

9. The passive device according to claim 1, wherein the mechanism comprises:
a valve disposed between the inlet and first and second outlets to selectively change flow of the rain water runoff from the inlet to one of the first outlet or second outlet;
a conduit having a third outlet having a smaller flow rate than the first outlet, the conduit having an inlet in a flow of the rain water running toward the first outlet such that a portion of the rain water runoff flowing towards the first outlet can flow through the third outlet;
a container having an inlet fluidly connected to the third outlet; and
a sub-mechanism for passively turning the valve from the first outlet to the second outlet when the predetermined initial amount of the rain water runoff accumulates in the container.

10. The passive device according to claim 9, wherein the sub-mechanism comprises:
the container is movable;
the valve includes a lever for changing the flow of the rain water runoff from the inlet to one of the first outlet or second outlet; and
a linkage connected to the container and to the lever such that upon the container accommodating the predetermined initial amount of the rain water runoff, the linkage changes the flow of the rain water runoff from the inlet to one of the first outlet or second outlet.

11. The passive device according to claim 9, wherein the container further comprises a valve for varying an amount of the predetermined initial amount of the rain water runoff

12. The passive device according to claim 1, wherein the mechanism comprises:
a first container having a first inlet fluidly connected to the first outlet for accumulating the predetermined initial amount of the rain water runoff, the first inlet having a ball valve seat; and
a ball movably restrained in the first container such that the ball seats in the ball valve seat when the predetermined initial amount of the rain water runoff accumulates in the first container.

13. A method for passively controlling rain water runoff, the method comprising:
directing the rain water runoff to an inlet;
directing a predetermined initial amount of the rain water runoff to a first outlet; and
passively directing a subsequent amount of the rain water runoff to a second outlet.
